(19) United States
(12) Patent Application Publication
(10) Pub. No.: US 2009/0240941 A1
(43) Pub. Date: Sep. 24, 2009

(54) METHOD AND APPARATUS FOR AUTHENTICATING DEVICE IN MULTI DOMAIN HOME NETWORK ENVIRONMENT

(75) Inventors: Yun-Kyung Lee, Daejeon (KR); Jin-Bum Hwang, Daejeon (KR); Hyung-Kyu Lee, Daejeon (KR); Geon-Woo Kim, Daejeon (KR); Do-Woo Kim, Daejeon (KR); Jong-Wook Han, Daejeon (KR); Kyo-Il Chung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/306,810

(22) PCT Filed: Jun. 28, 2007
(86) PCT No.: PCT/KR07/03134

§ 371 Date: Dec. 29, 2008

(30) Foreign Application Priority Data
Jun. 29, 2006 (KR) 10-2006-0059844
Sep. 28, 2006 (KR) 10-2006-0095009

(51) Int. Cl. H04L 9/32; H04L 9/06

(52) U.S. Cl. 713/169; 713/176; 380/277; 380/30

(57) ABSTRACT

A device authentication method and device authentication apparatus in a multi domain home network environment are provided. The method includes registering a new device in each local domain and issuing a local domain certificate; making an agreement between local domains in order to authenticate a device registered to another local domain; when the device registered to the home local domain or another local domain requests a service, authenticating the device via communication inside the local domains, thereby minimizing a user's intervention, making it easier to use the apparatus, reducing a device operation with regard to a device having limited performance, and making it easier to extend the apparatus.

### TECHNICAL FIELD

The present invention relates to a method and apparatus for authenticating a device in a multi domain home network environment, and more particularly, to a method and apparatus for authenticating a device in a multi domain home network environment thereby minimizing a user's intervention and device operation.

### BACKGROUND ART

Devices are conventionally authenticated using a symmetric key and a public key infrastructure (PKI).

By using the symmetric key, two devices share the same key, confirm that either has a common key, and authenticate each other. In this case, it is very difficult to manage communicating two devices to share the same key, and since the more the number of devices increases, the more the number of keys shared by devices increases, it is difficult to increase the number of devices.

The PKI makes it easier to manage a key and has a global structure requiring no identification of local domains, whereas a user must authorize a third party to issue a certificate of a user's device, and a root certification authority (hereinafter referred to as a “root CA”) is authorized to issue all certificates, so that the more the number of devices increases, the more the number of lower CAs and the size of a certificate revocation list (CRL) increase, which increases costs incurred in the management of the lower CAs and CRL. Further, when authentication between devices having limited computing power is performed, it is unlikely to build and verify the path of certificates. Although a private authentication method or a local authentication method such as a simple PKI (SPKI) has been proposed in order to overcome the above defects of the PKI, each device needs a certificate of each local domain, which causes inconvenience with users who manage devices.

### DISCLOSURE OF INVENTION

### Technical Problem

The present invention provides a method and apparatus for authenticating a device in a multi domain home network environment where a user's intervention is minimized for easier use of a non-expert.

The present invention also provides a method and apparatus for authenticating a device in a multi domain home network environment where an authentication operation of a device having limited performance is minimized.

The present invention also provides a method and apparatus for authenticating a device in a multi domain home network environment that can be easily extended although the number of devices increases.

### Technical Solution

According to an aspect of the present invention, there is provided a device authentication method performed by a home gateway in a multi domain home network environment including a plurality of local domains, the method comprising; receiving a cross-domain certificate used to authenticate the home gateway from a device registered to another local domain by making a mutual link agreement between the local domain and the another local domain through a public key infrastructure (PKI) to authenticate a device registered to the another local domain; issuing a local domain certificate used in a local domain to a device requesting registration; and verifying whether a service request is valid through the local domain certificate or the cross-domain certificate with regard to a device requesting the service.

The receiving a cross-domain certificate may comprise: requesting the mutual link agreement between local domains to a home gateway of the another local domain; receiving the cross-domain certificate authenticating the mutual link agreement between local domains from the home gateway receiving a request of the mutual link agreement; and receiving identity of a local domain that made the mutual link agreement and a public key of the home gateway of the local domain and storing the identity and the public key.

The issuing a local domain certificate may comprise: generating and sending a first random value to the device; receiving a value obtained by hashing at least one of the first random value, identity of the device, a second random value generated in the device, and a public key of the device using a secret key of the device; sending the hash value received from the device to a server sharing the secret key with the device to allow the hash value authenticated in the server; and if the hash value is verified to be valid, accepting the registration request of the device.

The verifying whether a service request is valid may further comprise: sending the first random value to the device requesting the service; receiving from the device the second random value generated in the device, the local domain certificate included in the device, and the value obtained by signing the first random value using the public key of the device; verifying the signature and the local domain certificate; and if the signature and the local domain certificate are verified to be valid, generating a session key to be shared with the device, and sending to the device a message obtained by encrypting the session key using the public key of the device and a message obtained by signing the session key and the second random value using the public key of the home gateway.

The verifying of whether the service request is valid may further comprise: if it is impossible to authenticate the local domain certificate, confirming information of a home local domain from the local domain certificate; requesting the home local domain to make the mutual link agreement, verifying the local domain certificate of the device using a public key of the home local domain acquired by making of the mutual link agreement, and verifying the signature received from the device; and if the verification result is valid, generating a session key to be shared with the device, and sending to the device a message obtained by encrypting the session key using the public key of the device, a message obtained by signing the session key and the second random value using the public key of the home gateway, and the cross-domain certificate issued from the home local domain.

According to another aspect of the present invention, there is provided a device authentication apparatus in a multi domain home network environment including a plurality of local domains, the apparatus comprising; a cross-domain authentication means making a mutual link agreement between a local domain and another local domain to authenticate a device registered to the another local domain through a PKI, and exchanging cross-domain certificates used to establish a public key and the agreement fact; a device registration means verifying the device and issuing a local domain certificate used in a local domain to a device requesting registration; and a device verification means receiving the local domain certificate from a device requesting a service, verifying the local domain certificate using a public key thereof or a public key acquired from the cross-domain authentication means, if the local domain certificate is valid, generating a session key to be shared with the device requesting the service, and sending the session key to the device.

According to another aspect of the present invention, there is provided a device authentication method performed by a server in a multi domain home network environment including a plurality of local domains, the method comprising; sharing and storing a secret key and secret ID provided to each device; receiving a request of a home gateway to verify a device that is to be registered; verifying the home gateway using a global certificate issued through a PKI; and the server, if the global certificate of the home gateway is valid, verifying the device using the secret key and secret ID provided to each device; and sending a verification result message of the device to the home gateway.

According to another aspect of the present invention, there is provided a device authentication method performed by a device in a multi domain home network environment including a plurality of local domains, the method comprising; storing a secret key provided for each device when the device is manufactured; requesting registration of a home local domain to a home gateway; as information used to verify the device, providing the home gateway with a value obtained by hashing at least one of a first random value provided from the home gateway according to the request, identity of the device, a second random value generated by the device, and a public key of the device using the secret key of the device; receiving from the home gateway a verification result including a message obtained by encrypting a public key of the home gateway and the second random value using the secret key of the device and a local domain certificate available in the home local domain issued by the home gateway;

and verifying the encrypted messages using the secret key of the device, if both messages are valid, establishing the public key of the home gateway as a public key of a root certification authority of the device, and storing the local domain certificate.

The method may further comprise: sending a service request message to the home gateway of the home local domain to which the device is registered; as information used to authenticate a device requesting a service, providing the home gateway with a message obtained by encrypting a third random value generated by the home gateway using a public key of the device, a local domain certificate of the device, and a fourth random value generated by the device; receiving a message obtained by encrypting a session key, between the device and the home gateway, generated from the home gateway that verifies the message using the public key of the device, and a message obtained by signing the session key and the fourth random value using the public key of the home gateway; and if the signed message is verified to be valid, decrypting the encrypted message using the public key of the device and acquiring the session key.

The method may further comprise: sending the service request message to a home gateway of a local domain other than the home local domain to which the device is registered; as information used to authenticate a device requesting a service, providing the home gateway with a message obtained by encrypting a third random value generated by the home gateway using a public key of the device, a local domain certificate of the device, and a fourth random value generated by the device; receiving a message obtained by encrypting a session key, between the device and the home gateway, generated from the home gateway that verifies the message using the public key of the device, a message obtained by signing the session key and the fourth random value using the public key of the home gateway, and a cross-domain certificate used to establish an agreement between the home gateway and the home gateway of the home local domain; and verifying the signed message and the cross-domain certificate, if the cross-domain certificate and the signature are valid, decrypting the encrypted message using the public key of the device and acquiring the session key.

### Advantageous Effects

As described above, the present invention divides an authentication layer into two authentication layers, and authenticates a device through an agreement between local domains, so that root CAs are distributed to home gateways, thereby securing extension, the registration of the device makes it possible to authenticate the device requesting a service in a different local domain, thereby minimizing a user's intervention, a certificate authentication path includes a single certificate, thereby reducing costs incurred in the building and verification of the path, after an agreement between local domains is finished, and all authentication process is carried out via communication inside local domains, thereby performing efficient authentication without access to outside local domains.

### BRIEF DESCRIPTION OF THE DRAWINGS

The above and other features and advantages of the present invention will become more apparent by describing in detail embodiments thereof with reference to the attached drawings in which:

FIG. 1 illustrates the structure of a device authentication system in a multi domain home network environment according to an embodiment of the present invention;

FIG. 2 is a flowchart illustrating a device registration operation of purchasing a device by a user and registering the device to a home gateway according to a device authentication method of the present invention;

FIG. 3 is a flowchart illustrating a device authentication operation when a device registered to a home local domain requests a service in a home local domain thereof according to a device authentication method of the present invention;

FIG. 4 is a flowchart illustrating an operation of making an agreement between local domains to authenticate a device without an additional registration process when the device registered to a home local domain requests a service in another local domain according to a device authentication method of the present invention;

FIG. 5 is a flowchart illustrating an operation of authenticating devices belonging to different local domains that make an agreement there between according to a device authentication method of the present invention; and

FIG. 6 is a block diagram of a device authentication apparatus according to an embodiment of the present invention.

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements.

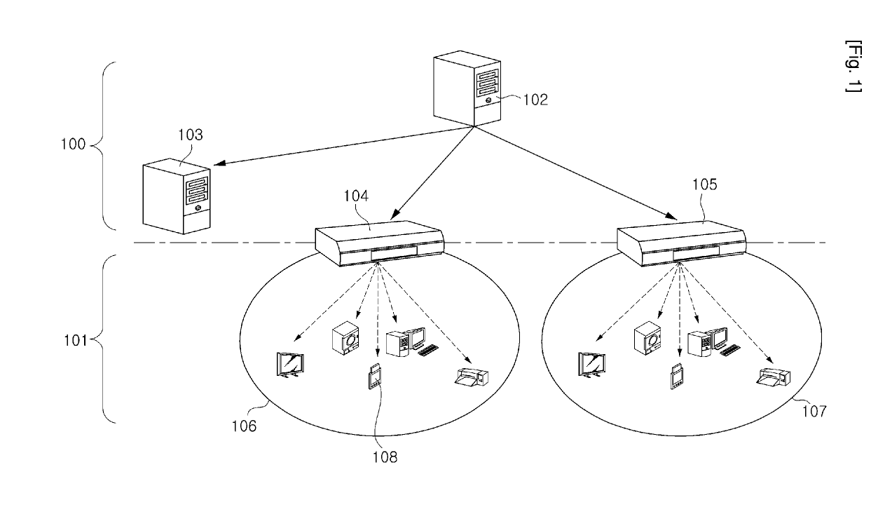

FIG. 1 illustrates the structure of a device authentication system in a multi domain home network environment according to an embodiment of the present invention. Referring to FIG. 1, the device authentication system comprises a third authentication server 102, a manufacturing company server 103 that authenticates a device 108 accessing to a home network, home gateways 104 and 105 that are installed at home and relay connections of devices at home and outside, local domains 106 and 107 that are independent home network areas and formed by the home gateways 104 and 105, and the device 108 connected to the home network.

The device authentication system is divided into a first public key-based authentication layer 100 according to a conventional authorized authentication system and a second public key-based authentication layer 101 according to each of the local domains 106 and 107 of the home network.

The first public key-based authentication layer 100, like the conventional authorized authentication system, performs authentication using the third authentication server 102 that serves as a root certification authority (CA). When the device 108 is registered in the home gateways 104 and 105, the first public key-based authentication layer 100 performs authentication between the manufacturing company server 103 and the home gateways 104 and 105. When the device 108 registered in the local domain 106 moves to the local domain 107 and requests a service, the first public key-based authentication layer 100 mutually authenticates the home gateways 104 and 105 of the local domains 106 and 107 to make an agreement of device authentication between the two local domains 106 and 107. Certificates that are issued between the home gateways 104 and 105 to perform the mutual device authentication between the two local domains 106 and 107 are referred to as cross-domain certificates.

The second public key-based authentication layer 101 issues certificates to devices registered at home using the home gateways 104 and 105 that serve as root CAs of the local domains 106 and 107, respectively. The certificates that are issued to the devices registered at home in the home gateways 104 and 105 are referred to as local domain certificates. The local domain certificates are used to authenticate the devices at home.

A device authentication method of the present invention based on the device authentication system illustrated in FIG. 1 may comprise a device registration operation of registering the device 108 in the local domain 106 of the home network, when the device 108 registered in the local domain 106 of the home network moves to the local domain 107; an operation of making an agreement between the local domains 106 and 107 to authenticate the device 108 without an additional registration process; and a device authentication operation of authenticating the device 108 when a service is requested in the local domain 107.

The aforementioned device registration operation, operation of making the agreement between the local domains 106 and 107, and device authentication operation are realized in the home gateways 104 and 105.

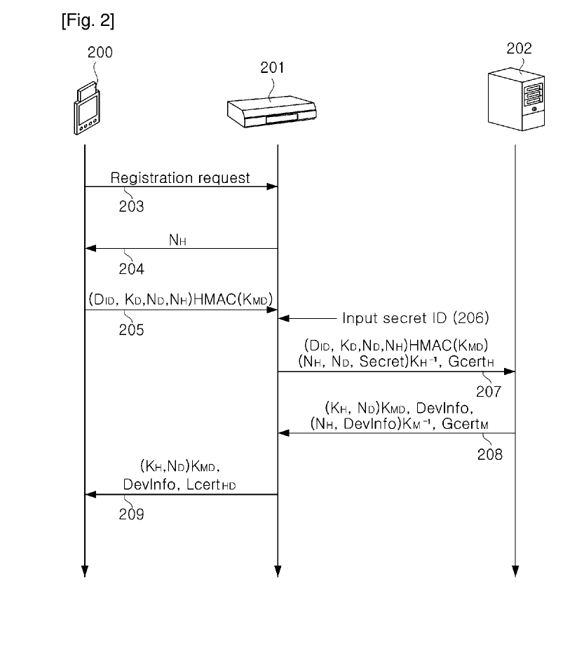

Each of the operations will now be described with reference to FIGS. 2 through 5.

In addition, referring to FIGS. 2 through 5, random values used to avoid a replay attack are divided into a first random value that is generated in a home gateway, and a second random value that is generated in the device 108 for the sake of understanding.

FIG. 2 is a flowchart illustrating the device registration operation by purchasing a device 200 by a user and registering the device 200 to a home gateway 201 at home according to a device authentication method of the present invention.

Referring to FIG. 2, the device 200 may be registered to the home gateway 201 of a home network, and a server 202 may verify the device 200 and be managed by a manufacturing company.

According to the device authentication method of the present invention, a device manufacturing company safely inserts a secret key K_{MD} provided to each device into the device 200, stores identification information ID identifying the device 200 and the secret key K_{MD} inserted into the device 200 in the server 202, and shares the ID and the secret key K_{MD}. When the user purchases the device 200, the device manufacturing company informs the user of a secret ID that is to be shared by the user and the server 202, and stores the secret ID in the server 202. The secret key K_{MD} and secret ID are used to authenticate the device 200 when the device 200 is registered to the home gateway 201.

The home gateway 201 receives its certificate (hereinafter referred to as a “global certificate Gcert_{H}” from a third authority through a first public key-based authentication layer.

In such an environment, the device 200 is authenticated and first registered in accordance with the following processes between the device 200, the home gateway 201, and the server 202.

The device 200 sends a registration request message to the home gateway 201 in order for the registration in a home local domain (Operation 203).

The home gateway 201 that receives the registration request message sends the optionally selected first random value N_{H} in order to avoid the replay attack (Operation 204).

The device 200 that sends the registration request message provides the home gateway 201 with information necessary for the authentication of itself. In more detail, the device 200 receives the first random value N_{H} from the home gateway 201 in response to the registration request message, generates a pair of public key K_{D} and secret key that is to be used by itself, and provides the home gateway 201 with a value, which is the information necessary for the authentication of itself, obtained by hashing at least one of the device ID D_{ID} for identifying itself, the public key K_{D}, the second random value N_{D} generated by itself, and the first random value N_{H} received from the home gateway 201 by using the secret key K_{MD} inserted into the device 200 when manufactured (Operation 205).

The home gateway 201 acquires the secret ID that is provided from the device manufacturing company when the device 200 is purchased (Operation 206).

The home gateway 201 verifies whether the hash value

(D_{ID},K_{D},N_{D},H_{H})HMAC(K_{MD})

received from the device 200 and the secret ID are valid by requesting the verification to the server 202 having the secret key K_{MD} and secret ID. To this end, the home gateway 201 sends a message in which the secret ID and first and second random values N_{H} and N_{D} are signed with its secret key K_{D}⁻¹, the global certificate Gcert_{H} issued through the first public key-based authentication layer 100, and the hash value received from the device 200 to the server 202 (Operation 207).

The server 202 sequentially verifies the hash value generated by the device 200 among the messages received from the home gateway 201 using the secret key K_{MD} of the device 200, the global certificate Gcert_{H} of the home gateway 201, and a message signed by the home gateway 201 using a public key K_{H} of the home gateway 201 included in the global certificate Gcert_{H}. If both messages generated by the device 200 and signed by the home gateway 201 are valid, the server 202 provides the home gateway 201 with the verification result, together with a message generated by hashing the public key K_{H} of the home gateway 201 and the second random value N_{D} of the device 200 by using the secret key K_{MD} of the device 200, information DevInfo on the device 200, a message generated by signing the first random value N_{H} and the device information DevInfo using a public key of the server 202, and a global certificate Gcert_{M} of the server 202 (Operation 208).

The home gateway 201 that receives the response from the server 202 verifies the received signature and global certificate Gcert_{M}, if the message is valid, issues a local domain certificate Lcert_{D} that is to be used in the second public key-based authentication layer to the device 200, and sends the message

(K_{H}N_{D})K_{MD}

including the hash value obtained by using the secret key K_{MD} of the device 200, the local domain certificate Lcert_{HD}, and the device information DevInfo to the device 200 (Operation 209).

The device 200 verifies the hash value received from the home gateway 201 using the secret key K_{MD} thereof, if the hash value is valid, establishes the public key K_{H} of the home gateway 201 acquired from the hash value as a public key of the root CA for the authentication of itself, and uses the issued local domain certificate Lcert_{D} as a certificate for authenticating itself in the local domain.

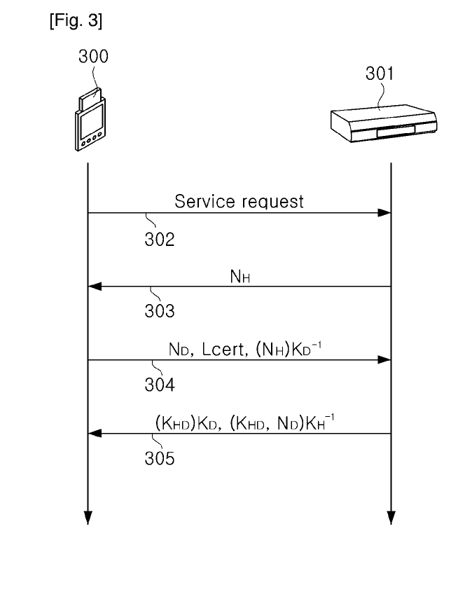

FIG. 3 is a flowchart illustrating the device authentication operation when a device 300 registered to the home local domain requests a service in a home local domain thereof.

Referring to FIG. 3, the device 300 is registered to a home gateway 301 of the home local domain to which the device 300 is registered according to the device registration operation illustrated in FIG. 2.

The device authentication operation is performed in the device 300 and the home gateway 301 according to the following processes.

The device 300 sends a service request message to the home gateway 301 (Operation 302). The home gateway 301 sends the first random value N_{H} to the device 300 in order to avoid the replay attack (Operation 303).

The device 300 provides the home gateway 301 with a value obtained by signing the first random value N_{H} of the home gateway 301 using the public key K_{D} thereof, the local domain certificate Lcert_{D} thereof issued in the registration operation, and the second random value N_{D} (Operation 304).

The home gateway 301 verifies the signature of the device 300 and the local domain certificate Lcert_{D}, if the verification result is valid, generates a session key K_{HD} of the device 300 so that the device 300 can receive the service, encrypts the session key K_{HD} using the public key K_{D} of the device 300, and provides the device 300 with the signature and the encryption key (Operation 305). In more detail, in Operation 305, the home gateway 301 sends a message generated by encrypting the session key K_{HD} using the public key K_{D} of the device 300 and the signature thereof with regard to the session key K_{HD} and second random value N_{D} to the device 300.

The device 300 verifies the signature received from the home gateway 301 and, if the signature is valid, acquires the session key K_{HD}.

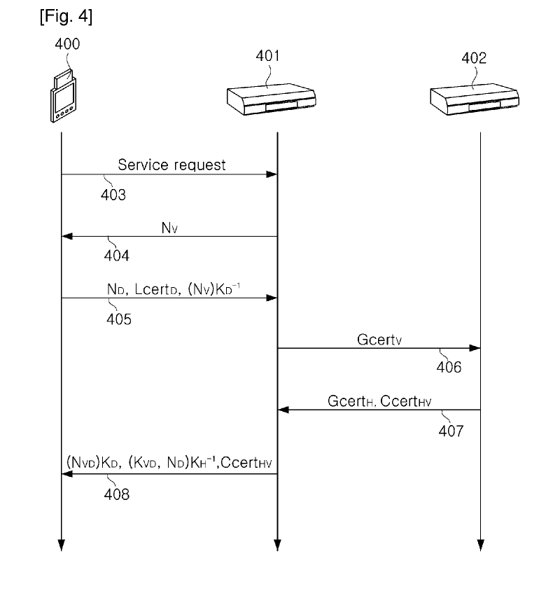

FIG. 4 is a flowchart illustrating an operation of making an agreement between local domains for authenticating a device 400 without an additional registration process when the device 400 registered to the home local domain wishes to receive a service in another local domain.

When the device registered to a home gateway of the home local domain moves to another local domain (hereinafter, the another local domain is referred to as a “visit local domain”, a device registered to a different local domain needs to be authenticated in a home gateway of the visit local domain so that the device can receive the service in the visit local domain.

However, as described above, when the home gateway of the home local domain is used as a root CA, since devices registered to different local domains have no root CA, it is impossible to verify a certificate issued in a different local domain.

To address this problem, the device authentication method of the present invention comprises the operation of making the agreement between local domains for mutually authenticating local domains registered between home gateways that serve as root CAs in each of the local domains.

Referring to FIG. 4, the device 400 visit the local domain other than the home local domain to which the device 400 is registered, a home gateway 401 serves as a root CA of the visit local domain, and a home gateway 402 serves as a root CA of the home local domain.

If the device 400 requests the service to the home gateway 401 of the visit local domain (Operation 403), the home gateway 401 of the visit local domain sends a first random value N_{V} to the device 400 that requested the service in order to perform authentication according to the device authentication process described above (Operation 404).

The device 400, like the device authentication operation described with reference to FIG. 3, sends a value obtained by signing the first random value N_{V} using a secret key K_{D}⁻¹ thereof, a local domain certificate Lcert_{D} thereof received from the home gateway 402 of the home local domain, and a newly generated second random value N_{D} to the home gateway 401 of the visit local domain 401 (Operation 405).

The home gateway 401 of the visit local domain verifies the local domain certificate Lcert_{D} of the device 400. However, since the home gateway 401 does not issue the local domain certificate Lcert_{D} of the device 400, it is impossible to verify the received local domain certificate Lcert_{D} of the device 400. Therefore, the home gateway 401 of the visit local domain acquires information on the home local domain included in the received local domain certificate Lcert_{D} of the device 400, provides the home gateway 402 of the home local domain to which the device 400 is registered with a global certificate Gcert_{V} thereof, and requests a link agreement used to authenticate a device registered to another local domain without carrying out a process of registering the device registered to another local domain (Operation 406). The global certificate Gcert_{V} of the home gateway 401 is issued to the home gateway 402 from the third authentication server 102 through the first public key-based authentication layer 100.

The home gateway 402 of the home local domain that receives the agreement request verifies the global certificate Gcert_{V} of the home gateway 401, if the global certificate Gcert_{V} is valid, issues a cross-domain certificate Ccert_{HV} to the home gateway 401 of the visit local domain, and sends a global certificate Gcert_{H} that is issued thereto through the first public key-based authentication layer 100 to the home gateway 401 (Operation 407).

The home gateway 401 of the visit local domain verifies the global certificate Gcert_{H} of the home gateway 402 of the home local domain, and, if the global certificate Gcert_{H} is valid, stores a local domain name of the home gateway 402 of the home local domain and a public key of the home gateway 402. As such, the home gateway 401 of the visit local domain can verify the local domain certificate Lcert_{D} of the device 400 after verifying the global certificate Gcert_{H} of the home gateway 402 of the home local domain, thereby verifying the signature of the message received from the device 400 in Operation 405. If the signature of the message is valid, the home gateway 401 of the visit local domain generates a session key K_{VD} that is to be shared with the device 400, and sends a message encrypted using the public key of the device 400, a message generated by signing the session key K_{VD} and second random value N_{D} using the public key thereof, and the cross-domain certificate Ccert_{HV} issued from the home gateway 402 of the home local domain to the device 400 (Operation 408).

The device 400 verifies the signature of the home gateway 401 and the cross-domain certificate Ccert_{HV} to confirm whether the session key K_{VD} is acquired from the valid home gateway 401.

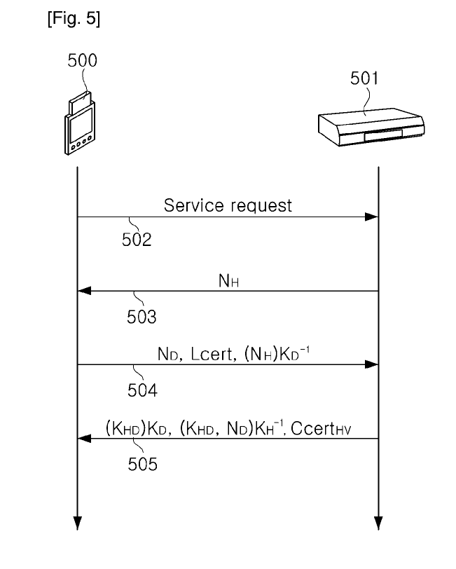

FIG. 5 is a flowchart illustrating an operation of authenticating a device 500 belonging to different local domains that make an agreement there between.

Referring to FIG. 5, the device 500 requests a service in a visit local domain that made the agreement with a home local domain to which the device 500 is registered, and a home gateway 501 is included in the visit local domain.

For mutual authentication between devices, a client device requests a service, and informs a service device of identity of a home gateway of a local domain to which the client device belongs. The service device requests a public key of the home gateway corresponding to the identity to a home gateway to which the service device belongs, and verifies a certificate of the client device using the public key of the home gateway. When the mutual authentication is necessary, the home gateway of a service local domain sends to the client device a certificate that is issued to the home gateway of the service local domain by the home gateway of the client device. The operation of authenticating the device 500 registered to another local domain using the home gateway of the visit local domain will now be described.

If the device 500 requests the service to the home gateway 501 of the visit local domain, the home gateway 501 of the visit local domain sends a first random value N_{H} to the device 500 (Operation 503).

The device 500 sends a value obtained by signing the first random value N_{H} using a secret key thereof, a local domain certificate Lcert thereof, and a newly generated second random value N_{D} to the home gateway 501 (Operation 504).

The home gateway 501 verifies the local domain certificate Lcert of the device 500 using the public key of the home gateway of the home local domain obtained through the aforementioned agreement operation, and verifies a signature of the message. If the signature is valid, the home gateway 501 generates a session key K_{VD} that is to be shared with the device 500, and sends a message encrypted using a public key of the device 500, a message obtained by signing the session key K_{VD} and second random value N_{D} using the public key of the home gateway 501, and the cross-domain certificate Ccert_{HV} issued from the home gateway of the home local domain of the device 500 through the agreement operation to the device 500 in response to the service request (Operation 505).

The device 500 verifies the cross-domain certificate Ccert_{HV} to confirm if it is the home gateway that made the agreement, verifies the signature of the received message, and, if the signature is valid, uses the received session key K_{VD}.

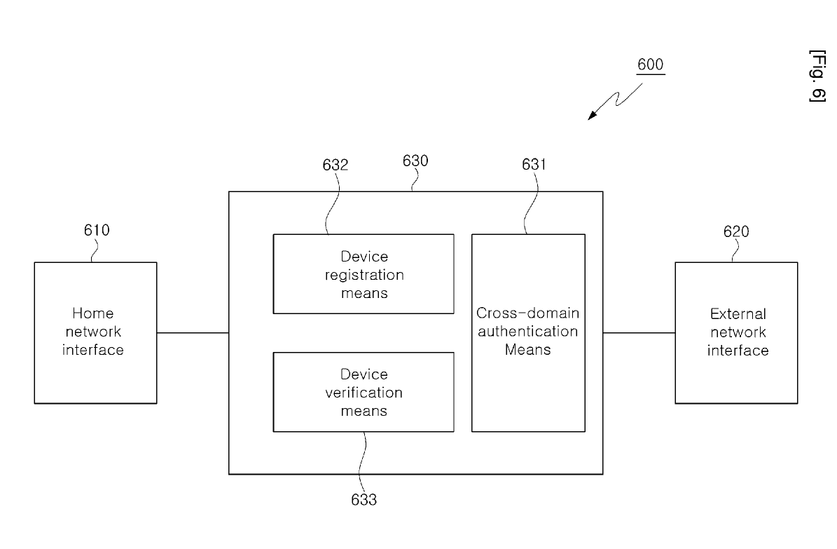

FIG. 6 is a block diagram of a device authentication apparatus 630 according to an embodiment of the present invention.

The device authentication apparatus 630 of the present invention can be realized in a home gateway of each local domain in a multi domain home network environment.

Referring to FIG. 6, a home gateway 600 includes the device authentication apparatus 630, a home network interface 610 connects the home gateway 600 and a plurality of devices, and an external network interface 620 connects the home gateway 600 to an external network. Devices, other home gateways, and servers make a communication through the home network interface 610 and the external network interface 620.

The device authentication apparatus 630 includes a cross-domain authentication means 631 that makes a mutual link agreement between a local domain and another local domain to authenticate a device registered to the another local domain through a public key infrastructure (PKI), and exchanges a cross-domain certificate to establish a public key and the agreement fact, a device registration means 632 that verifies the device with respect to a device requesting registration thereof and issues a local domain certificate used in the local domain, and a device verification means 633 that receives the local domain certificate from the device requesting the service, verifies the local domain certificate using a public key thereof or a public key obtained by the cross-domain authentication means 631, if the local domain certificate is valid, generates a session key that is to be shared with the device requesting the service, and provides the session key with the device.

The cross-domain authentication means 631 authenticates an authentication apparatus, i.e., between home gateways, through the PKI.

The cross-domain authentication means 631 operates when the device verification means 633 receives the local domain certificate of the device requesting the service but cannot verify the local domain certificate, and makes a link agreement with an authentication apparatus of a home local domain recorded in the received local domain certificate.

The device registration means 632 receives verification information from the device requesting the registration thereof, and verifies the received information through a server sharing the verification information with the device. In more detail, the verification information includes a secret key inserted into the device when the device is manufactured and secret ID of the device provided when the device is purchased.

The device registration means 632 generates a first random value in order to avoid a replay attack and sends the first random value to the device requesting registration thereof, receives from the device, as the verification information, a value obtained by hashing at least one of the first random value, identity of the device, a second random value generated in the device, and a public key of the device using a secret key of the device, and sends the received hash value to a server sharing the secret key with the device to verify the hash value. Mutual authentication between the server and home gateway is made through the PKI.

The device verification means 633 receives from the device requesting the service, as the verification information, a local domain certificate issued to the device, verifies the local domain certificate, if the local domain certificate is valid, generates a session key of the device, encrypts the session key, and provides the device with the encrypted session key and signature.

In this regard, when it is impossible to verify the local domain certificate that is issued in a different local domain, the device verification means 633 provides the cross-domain authentication means 631 with information on a home local domain recorded in the received local domain certificate and requests the agreement.

If a public key and cross-domain certificate of the home local domain are acquired as a result of the agreement, the device verification means 633 verifies the local domain certificate received via the public key, if the verification result is valid, generates a session key to the device, encrypts the session key, sends the encrypted session key together with signature thereof and the cross-domain certificate to the device, and informs that it is the authentication apparatus that made the agreement.

While the present invention has been particularly shown and described with reference to exemplary embodiments thereof, it will be understood by those of ordinary skill in the art that various changes in form and detail may be made therein without departing from the spirit and scope of the present invention as defined by the following claims.

### INDUSTRIAL APPLICABILITY

As described above, the present invention divides an authentication layer into two authentication layers, and authenticates a device through an agreement between local domains, so that root CAs are distributed to home gateways, thereby securing extension, the registration of the device makes it possible to authenticate the device requesting a service in a different local domain, thereby minimizing a user's intervention, a certificate authentication path includes a single certificate, thereby reducing costs incurred in the building and verification of the path, after an agreement between local domains is finished, and all authentication process is carried out via communication inside local domains, thereby performing efficient authentication without access to outside local domains.

1. A device authentication method performed by a home gateway of each local domain in a multi domain home network environment including a plurality of local domains, the method comprising;
receiving a cross-domain certificate used to authenticate the home gateway from a device registered to another local domain by making a mutual link agreement between the local domain and the another local domain through a public key infrastructure (PKI) to authenticate a device registered to the another local domain;
issuing a local domain certificate used in a local domain to a device requesting registration; and
verifying whether a service request is valid through the local domain certificate or the cross-domain certificate with regard to a device requesting the service.

2. The method of claim 1, wherein the receiving a cross-domain certificate comprises:
requesting the mutual link agreement between local domains to a home gateway of the another local domain;
receiving the cross-domain certificate authenticating the mutual link agreement between local domains from the home gateway receiving a request of the mutual link agreement; and
receiving identity of a local domain that made the mutual link agreement and a public key of the home gateway of the local domain and storing the identity and the public key.

3. The method of claim 2, wherein, in the receiving a cross-domain certificate, mutual authentication between home gateways is made using a global certificate issued in a third authority.

4. The method of claim 1, wherein the receiving a cross-domain certificate is performed when the service request is received from the device registered to the another local domain.

5. The method of claim 1, wherein the issuing a local domain certificate comprises:
verifying whether the device is normal,
wherein the local domain certificate is issued to the verified device.

6. The method of claim 5, wherein the issuing a local domain certificate further comprises:
generating and sending a first random value to the device;
receiving a value obtained by hashing at least one of the first random value, identity of the device, a second random value generated in the device, and a public key of the device using a secret key of the device;
sending the hash value received from the device to a server sharing the secret key with the device to allow the hash value authenticated in the server; and
if the hash value is verified to be valid, accepting the registration request of the device.

7. The method of claim 6, wherein the issuing a local domain certificate further comprises:
receiving a secret ID of the device requesting registration and sharing with the server; and
sending a message obtained by hashing the secret ID and the first and second random values and signing the message using a secret key of the home gateway to the server to allow the secret ID authenticated.

8. The method of claim 7, wherein the issuing a local domain certificate further comprises:
receiving from the server a message obtained by hashing the public key of the home gateway and the second random value using the secret key of the device, a message obtained by encrypting information on the device and the first random value using a public key of the server, and a global certificate issued to the server through the PKI, as the verification result.

9. The method of claim 8, wherein the issuing a local domain certificate further comprises:
verifying the messages received from the server, if the messages are valid, issuing the local domain certificate, and sending the message obtained by hashing the public key of the home gateway and the second random value using the secret key of the device, the information on the device and the local domain certificate to the device.

10. The method of claim 2, wherein the verifying whether a service request is valid further comprises:
sending the first random value to the device requesting the service;
receiving from the device the second random value generated in the device, the local domain certificate included in the device, and the value obtained by signing the first random value using the public key of the device;
verifying the signature and the local domain certificate; and
if the signature and the local domain certificate are verified to be valid, generating a session key to be shared with the device, and sending to the device a message obtained by encrypting the session key using the public key of the device and a message obtained by signing the session key and the second random value using the public key of the home gateway.

11. The method of claim 10, wherein the verifying whether a service request is valid further comprises:
if it is impossible to authenticate the local domain certificate, confirming information of a home local domain from the local domain certificate;
requesting the home local domain to make the mutual link agreement, verifying the local domain certificate of the device using a public key of the home local domain acquired by making of the mutual link agreement, and verifying the signature received from the device; and
if the verification result is valid, generating a session key to be shared with the device, and sending to the device a message obtained by encrypting the session key using the public key of the device, a message obtained by signing the session key and the second random value using the public key of the home gateway, and the cross-domain certificate issued from the home local domain.

12. A device authentication apparatus in a multi domain home network environment including a plurality of local domains, the apparatus comprising;
a cross-domain authentication means making a mutual link agreement between a local domain and another local domain to authenticate a device registered to the another local domain through a PKI, and exchanging cross-domain certificates used to establish a public key and the agreement fact;
a device registration means verifying the device and issuing a local domain certificate used in a local domain to a device requesting registration; and
a device verification means receiving the local domain certificate from a device requesting a service, verifying the local domain certificate using a public key thereof or a public key acquired from the cross-domain authentication means, if the local domain certificate is valid, generating a session key to be shared with the device requesting the service, and sending the session key to the device.

13. The apparatus of claim 12, wherein the cross-domain authentication means authenticates between apparatuses that link a global certificate of each authentication apparatus through a PKI, issues a cross-domain certificate used to establish a link agreement or stores the cross-domain certificate.

14. The apparatus of claim 13, wherein the cross-domain authentication means, if the device verification means does not verify the local domain certificate of the device requesting the service, requests the link agreement to an apparatus of a home local domain recorded in the local domain certificate according to a request of the device verification means.

15. The apparatus of claim 12, wherein the device registration means generates and sends a first random value to the device requesting registration, receives from the device, as verification information, a value obtained by hashing at least one of the first random value, identity of the device, a second random value generated in the device, and a public key of the device using a secret key of the device, and sends the hash value received to a server sharing the secret key with the device to allow the hash value authenticated in the server.

16. The apparatus of claim 15, wherein the device registration means receives a secret ID of the device requesting registration and shared with the server, and sends a message obtained by hashing the secret ID and the first and second random values and signing the message using a secret key thereof to the server to allow the secret ID authenticated.

17. A device authentication method performed by a server in a multi domain home network environment including a plurality of local domains, the method comprising;
sharing and storing a secret key and secret ID provided to each device;
receiving a request of a home gateway to verify a device that is to be registered;
verifying the home gateway using a global certificate issued through a PKI; and
if the global certificate of the home gateway is valid, verifying the device using the secret key and secret ID provided to each device; and
sending a verification result message of the device to the home gateway.

18. The method of claim 17, wherein the receiving a request of the home gateway to verify the device that is to be registered comprises:
receiving a message obtained by hashing at least one of identity of the device, a public key of the device, a first random value generated by the home gateway, and a second random value generated by the device using a secret key of the device, a message obtained by hashing the secret ID of the device acquired by the home gateway and the first and second random values and signing the message using a public key of the home gateway, and a global certificate of the home gateway.

19. The method of claim 18, wherein the verifying a device using the secret key and secret ID provided to each device comprises:
verifying the message obtained by hashing at least one of identity of the device, the public key of the device, the first random value generated by the home gateway, and the second random value generated by the device using the secret key of the device;
after verifying the global certificate of the home gateway, verifying the message signed using a public key of the home gateway confirmed in the global certificate; and
if both verification results are valid, determining the device to be valid.

20. The method of claim 19, wherein the verification result message of the device that is sent to the home gateway comprises at least one of a message obtained by encrypting the public key of the home gateway and the second random value using the secret key of the device, information on the device, a message obtained by encrypting the information on the device and the first random value using a public key of the server, and a global certificate issued to the server through the PKI.

21. A device authentication method performed by a device in a multi domain home network environment including a plurality of local domains, the method comprising;
storing a secret key provided for each device when the device is manufactured;
requesting registration of a home local domain to a home gateway;
as information used to verify the device, providing the home gateway with a value obtained by hashing at least one of a first random value provided from the home gateway according to the request, identity of the device, a second random value generated by the device, and a public key of the device using the secret key of the device;
receiving from the home gateway a verification result including a message obtained by encrypting a public key of the home gateway and the second random value using the secret key of the device and a local domain certificate available in the home local domain issued by the home gateway; and
verifying the encrypted messages using the secret key of the device, if both messages are valid, establishing the public key of the home gateway as a public key of a root certification authority of the device, and storing the local domain certificate.

22. The method of claim 21, further comprising:
sending a service request message to the home gateway of the home local domain to which the device is registered;
as information used to authenticate a device requesting a service, providing the home gateway with a message obtained by encrypting a third random value generated by the home gateway using a public key of the device, a local domain certificate of the device, and a fourth random value generated by the device;
receiving a message obtained by encrypting a session key, between the device and the home gateway, generated from the home gateway that verifies the message using the public key of the device, and a message obtained by signing the session key and the fourth random value using the public key of the home gateway; and
if the signed message is verified to be valid, decrypting the encrypted message using the public key of the device and acquiring the session key.

23. The method of claim 21, further comprising:
sending the service request message to a home gateway of a local domain other than the home local domain to which the device is registered;
as information used to authenticate a device requesting a service, providing the home gateway with a message obtained by encrypting a third random value generated by the home gateway using a public key of the device, a local domain certificate of the device, and a fourth random value generated by the device;
receiving a message obtained by encrypting a session key, between the device and the home gateway, generated from the home gateway that verifies the message using the public key of the device, a message obtained by signing the session key and the fourth random value using the public key of the home gateway, and a cross-domain certificate used to establish an agreement between the home gateway and the home gateway of the home local domain; and
verifying the signed message and the cross-domain certificate, if the cross-domain certificate and the signature are valid, decrypting the encrypted message using the public key of the device and acquiring the session key.
